(19) United States
(12) Patent Application Publication
(10) Pub. No.: US 2018/0085902 A1
(43) Pub. Date: Mar. 29, 2018

(54) Seal Installation Tool

(71) Applicant: Joseph Engle, Riverview, MI (US)

(72) Inventor: Joseph Engle, Riverview, MI (US)

(21) Appl. No.: 15/276,264

(22) Filed: Sep. 26, 2016

(51) Int. Cl. B25B 27/00; B25B 27/14

(52) U.S. Cl. CPC B25B 27/0028; B25B 27/14

(57) ABSTRACT

A seal installation tool for installing seals in vehicles includes a tube that has a first end and a second end. The first end is closed and the second end is open. The second end is sized such that the second end is configured for reversibly coupling to a seal, such as seals for transmissions and rear ends of a vehicle. The tube is configured to position the seal at an installation site. The first end is configured for impacting with an impactor to apply pressure evenly through the second end to the seal, such that the seal is sealably coupled to the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to seal installation tools and more particularly pertains to a new seal installation tool for installing seals in vehicles.

### BRIEF SUMMARY OF THE INVENTION

An embodiment of the disclosure meets the needs presented above by generally comprising a tube that has a first end and a second end. The first end is closed and the second end is open. The second end is sized such that the second end is configured for reversibly coupling to a seal, such as seals for transmissions and rear ends of a vehicle. The tube is configured to position the seal at an installation site. The first end is configured for impacting with an impactor to apply pressure evenly through the second end to the seal, such that the seal is sealably coupled to the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a seal installation tool according to an embodiment of the disclosure.

FIG. 2 is a side view of an embodiment of the disclosure.

FIG. 3 is a cross-sectional view of an embodiment of the disclosure.

FIG. 4 is a side view of an embodiment of the disclosure.

FIG. 5 is an in-use view of an embodiment of the disclosure.

### DETAILED DESCRIPTION OF THE INVENTION

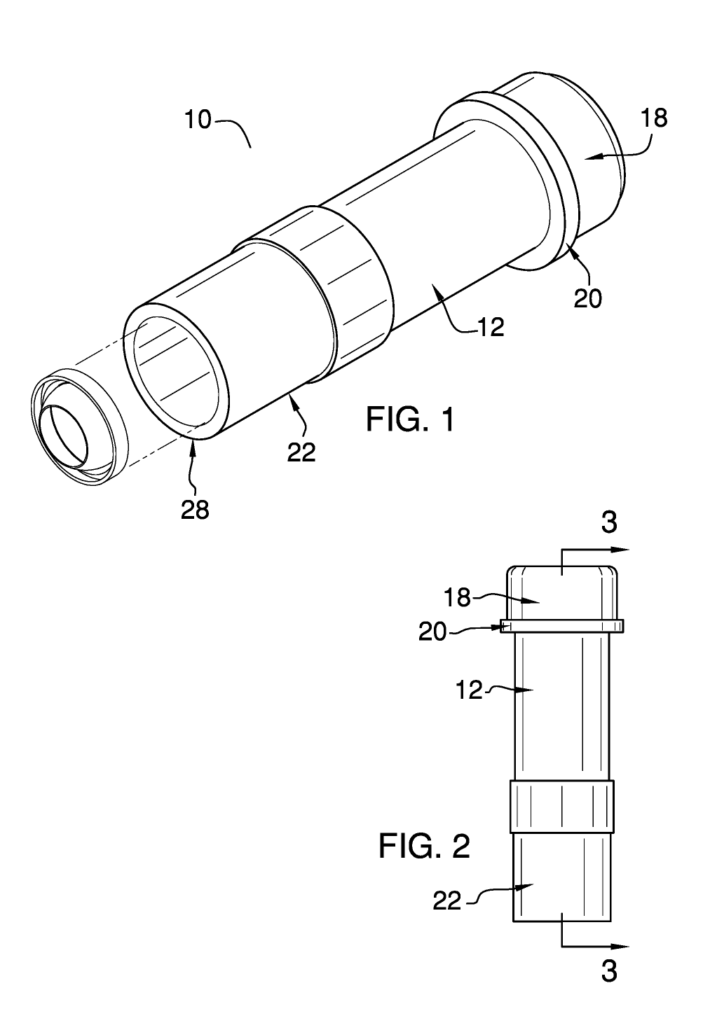

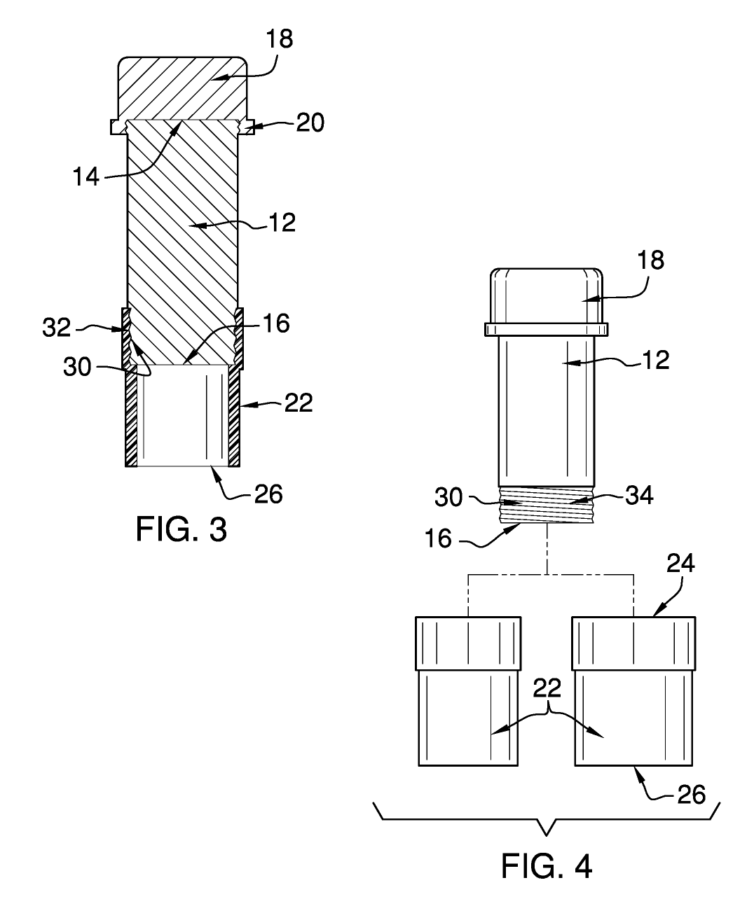

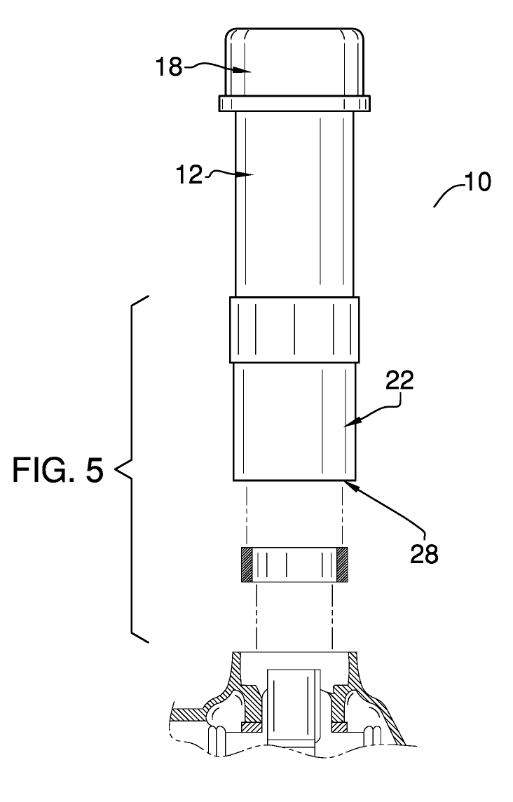

With reference now to the drawings, and in particular to FIGS. 1 through 5 thereof, a new seal installation tool embodying the principles and concepts of an embodiment of the disclosure and generally designated by the reference numeral 10 will be described.

As best illustrated in FIGS. 1 through 5, the seal installation tool 10 generally comprises a tube 12 that has a first end 14 and a second end 16. In one embodiment, the first end 14 is closed and the second end 16 is open. In another embodiment, the tube 12 comprises metal.

In yet another embodiment, the first end 14 is open and externally threaded. In this embodiment, the tool 10 comprises a cap 18 that is complementary to the first end 14 of the tube 12. The cap 18 comprises metal. The cap 18 is threadedly couplable to the first end 14 of the tube 12 such that the cap 18 is configured for impacting with an impactor. In still yet another embodiment, a lip 20 is coupled to a perimeter of the cap 18.

In one embodiment, each of a plurality of adaptors 22 has a first terminus 24 and a second terminus 26. The first termini 24 are configured to couple to the second end 16 of the tube 12. Each second terminus 26 has a circumference 28 that is complementary to a seal. The second terminus 26 is configured to reversibly couple to the seal. In another embodiment, the adaptors 22 comprise plastic. In yet another embodiment, the adaptors 22 comprise polyvinylchloride.

In one embodiment, a first coupler 30 is coupled to the tube 12 proximate to the second end 16. Each of a plurality of second couplers 32 is complementary to the first coupler 30. Each second coupler 32 is coupled proximate to the first terminus 24 of a respective adaptor 22. The first coupler 30 is positioned to selectively couple to a respective second coupler 32, such that a respective adaptor 22 is coupled to the tube 12. In another embodiment, the first coupler 30 comprises male threads 34.

In use, the first coupler 30 is positioned to selectively couple to a respective second coupler 32, such that a respective adaptor 22 is coupled to the tube 12. The second termini 26 are configured to reversibly couple to a seal, such as seals for transmissions and rear ends of a vehicle. The tube 12 is configured to position the seal at an installation site. The first end 14 is configured for impacting with an impactor to apply pressure evenly through the second end 16 to the seal. The seal is sealably coupled to the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A seal installation tool comprising:
a tube having a first end and a second end, said first end being closed, said second end being open; and
wherein said second end is sized such that said second end is configured for reversibly coupling to a seal, such as seals for transmissions and rear ends of a vehicle, such that said tube is configured for positioning the seal at an installation site, wherein said first end is configured for impacting with an impactor to apply pressure evenly through said second end to the seal, such that the seal is sealably coupled to the vehicle.

2. The tool of claim 1, further including said tube comprising metal.

3. The tool of claim 1, further comprising:
said first end being open, said first end being externally threaded;
a cap, said cap being complementary to said first end of said tube, said cap comprising metal; and
wherein said cap is threadedly couplable to said first end of said tube such that said cap is configured for impacting with an impactor.

4. The tool of claim 3, further including a lip, said lip being coupled to a perimeter of said cap.

5. The tool of claim 1, further including a plurality of adaptors, each said adaptor having a first terminus and a second terminus, said first terminus being configured for coupling to said second end of said tube, said second terminus having a circumference, said circumference being complementary to a seal, such that said second terminus is configured to reversibly couple to the seal.

6. The tool of claim 5, further including said adaptors comprising plastic.

7. The tool of claim 6, further including said adaptors comprising polyvinylchloride.

8. The tool of claim 5, further including comprising:
a first coupler coupled to said tube proximate to said second end;
a plurality of second couplers, said second couplers being complementary to said first coupler, each said second coupler being coupled proximate to said first terminus of a respective said adaptor; and
wherein said first coupler is positioned on said tube such that said first coupler is positioned for selective coupling to a respective said second coupler, such that a respective said adaptor is coupled to said tube.

9. The tool of claim 8, further including said first coupler comprising male threads.

10. A seal installation tool comprising:
a tube having a first end and a second end, said first end being closed, said second end being open, said tube comprising metal;
a plurality of adaptors, each said adaptor having a first terminus and a second terminus, said first terminus being configured for coupling to said second end of said tube, said second terminus having a circumference, said circumference being complementary to a seal, such that said second terminus is configured to reversibly couple to the seal, said adaptors comprising plastic, said adaptors comprising polyvinylchloride;
a first coupler coupled to said tube proximate to said second end, said first coupler comprising male threads;
a plurality of second couplers, said second couplers being complementary to said first coupler, each said second coupler being coupled proximate to said first terminus of a respective said adaptor, wherein said first coupler is positioned on said tube such that said first coupler is positioned for selective coupling to a respective said second coupler, such that a respective said adaptor is coupled to said tube; and
wherein said first coupler is positioned on said tube such that said first coupler is positioned for selective coupling to a respective said second coupler, such that a respective said adaptor is coupled to said tube; such that said second terminus is configured for reversibly coupling to a seal, such as seals for transmissions and rear ends of a vehicle, such that said tube is configured for positioning the seal at an installation site, wherein said first end is configured for impacting with an impactor to apply pressure evenly through said second end to the seal, such that the seal is sealably coupled to the vehicle.

11. The tool of claim 10, further comprising:
said first end being open, said first end being externally threaded;
a cap, said cap being complementary to said first end of said tube, said cap comprising metal;
a lip, said lip being coupled to a perimeter of said cap; and
wherein said cap is threadedly couplable to said first end of said tube such that said cap is configured for impacting with an impactor.
